(19) United States
(12) Patent Application Publication
(10) Pub. No.: US 2023/0327188 A1
(43) Pub. Date: Oct. 12, 2023

(54) MOLTEN FLUID APPARATUS WITH REINFORCED SOLID ELECTROLYTE

(71) Applicant: Vissers Battery Corporation, Wheaton, IL (US)

(72) Inventor: Daniel R. Vissers, Wheaton, IL (US)

(21) Appl. No.: 18/128,704

(22) Filed: Mar. 30, 2023

Related U.S. Application Data
(60) Provisional application No. 63/328,433, filed on Apr. 7, 2022.

(51) Int. Cl. H01M 10/0562

(52) U.S. Cl. CPC H01M 10/0562; H01M 2300/008

(57) ABSTRACT

A battery includes a fluid negative electrode and a fluid positive electrode separated by a solid electrolyte reinforced by a reinforcing structure where the electrodes are molten and the solid electrolyte is solid at least at an operating temperature. The reinforcing structure includes at least one component positioned between the solid electrolyte and one of the fluid electrodes and includes an open structure that allows fluid electrode material to extend through the component to contact the solid electrolyte. In one example, the fluid negative electrode comprises lithium (Li), the fluid positive electrode comprises sulfur (S) and the solid electrolyte comprises lithium iodide (LiI).

### CLAIM OF PRIORITY

The present application claims priority to Provisional Application No. 63/328,433, entitled “MOLTEN FLUID APPARATUS WITH REINFORCED SOLID ELECTROLYTE”, docket number VCB007P, filed Apr. 7, 2022, which is assigned to the assignee hereof and hereby expressly incorporated by reference in its entirety.

### FIELD

This invention generally relates to thermal batteries and more particularly to methods, devices, and systems with molten fluid electrodes with a reinforced solid electrolyte.

### BACKGROUND

A battery generally includes a positive electrode (cathode), a negative electrode (anode) and an electrolyte. A battery typically includes current collectors within the electrodes that direct electrical current to the terminals of the battery. Attempts have been made to use fluids for electrodes where one or both of the electrodes are maintained in a fluid state by heating the electrode material. These batteries are sometimes referred to as thermal batteries or high temperature batteries and include, for example, devices sometimes referred to as liquid-metal batteries and rechargeable liquid-metal batteries.

### BRIEF DESCRIPTION OF THE DRAWINGS

It is to be understood that the drawings are solely for purpose of illustration and do not define the limits of the appended claims. Furthermore, the components in the figures are not necessarily to scale. In the figures, like reference numerals designate corresponding parts throughout the different views.

FIG. 1A is a block diagram of a cross-sectional view of an example of a battery apparatus including a reaction chamber having fluid electrodes separated by a reinforced solid electrolyte including a solid electrolyte with a reinforcing structure positioned between the solid electrolyte and each of the electrodes.

FIG. 1B is a block diagram of a cross-sectional view of an example of a battery with electrolyte reinforcing current collectors where components of the reinforcing structure form current collectors.

FIG. 2 is a block diagram of a cross-sectional view of an example of a battery with a reinforcing structure including a negative region component, a positive region component, and a third component.

FIG. 3 is a block diagram of a cross-sectional view of an example of a battery where the third component is a sealing component.

FIG. 4 is an illustration of an example of a block of open cell foam suitable for use as a reinforcing structure component to reinforce the solid electrolyte within a thermal battery.

FIG. 5 is an illustration of an example of a section of wire mesh structure suitable for use as a reinforcing structure component to reinforce the solid electrolyte within a thermal battery.

### DETAILED DESCRIPTION

Thermal batteries have several advantages over other types of batteries. The relatively low cost, high energy density, and high power density of thermal batteries (high temperature batteries) make these types of batteries highly attractive for several uses. Unfortunately, the safety issues with these devices have constrained widespread adoption. Due to highly energetic chemistry, thermal batteries have suffered from dangerous risks of fire and explosion. Conventional thermal battery designs include two pools of fluid (i.e., molten) materials separated by a third material. If the third material fails and allows the molten materials to mix and react, an immense amount of thermal energy is released in a short period of time. These conditions often lead to a dangerous fire condition or explosion. This severe limitation still continues today although the demand for a safe thermal battery has existed since its inception of thermal batteries during World War II. Several decades of attempts have not resulted in an adequate solution to the problem. For example, some attempts include using a gravitational flow battery design in which one of the molten active materials is contained in a large reservoir located physically above a smaller reaction chamber where the walls of the reaction chamber are a solid electrolyte. On the other side of the solid electrolyte is a large reservoir of the other molten active material. In the event that the solid electrolyte fails and the two molten active materials are allowed to mix, the hope is that the solid products that are formed by the chemical reaction of the mixing of the two molten active materials will limit the flow of the active materials from the large reservoir located physically above with the other large reservoir of the other molten active material. The gravitational flow battery design attempt fails because the solid products that are intended to block the flow from the upper reservoir do not form into a cohesive mass that is able to block the flow at the operating temperature of the thermal battery. Therefore, the mixing of the two molten active materials is only slowed by this design and is insufficient to prevent a thermal runaway event. Other attempts include changing the chemistry of the molten active materials to a metal halide chemistry such that a solid electrolyte failure does not cause a thermal runaway event. Unfortunately, this technique comes at the cost of decreasing the specific energy density (kWh/kg) and the volumetric energy density (kWh/l) to a point where the thermal battery is no longer a viable solution for many applications.

Research in thermal batteries has even been abandoned by some due to the high danger. For example, a major auto manufacturer developed a fleet of electric vehicles that used thermal sodium-sulfur batteries in 1993. During the testing, two vehicles burst into flames while charging. As a result of these fires, the manufacturer ended its thermal sodium-sulfur battery program and the U.S. Department of Energy stopped funding thermal battery research. This is despite the enormous advantages that a safe thermal battery would provide to the electric vehicle industry as well as other industries. The relative light weight and low cost of thermal batteries clearly make these devices the best choice for use in electric vehicles if the danger of fire is mitigated.

Thermal batteries provide several advantages over other batteries including exhibiting a high gravimetric energy density (kWh/kg), high volumetric energy density, high gravimetric power density, and high volumetric power density at low cost. Conventional thermal batteries with fluid electrodes, however, suffer from a significant safety limitation. The electrolyte separators used in conventional thermal batteries include liquid electrolytes such as molten salts and brittle solid electrolytes such as ceramic and glass. Liquid electrolytes are limited in several ways. For example, during operation of these types of batteries, chemical species of the electrode materials are produced and permeate the electrolyte decreasing performance. Eventually, these byproducts in the electrolyte result in the battery ceasing to operate. Ceramic and glass electrolytes, on the other hand, can easily fail because of their brittle structure. As discussed above, significant fire conditions and explosions occur when the molten electrode materials come in contact with each other after the solid electrolyte separator is breached.

Therefore, the strength and integrity of the solid electrolyte is critical for safety in thermal batteries with molten electrodes. While minimizing the thickness of the electrolyte leads to higher current flow and power production with less internal heat generation, thinner electrolytes are more susceptible to failure, especially where the electrolyte is glass or ceramic and is prone to cracking. Therefore, safety is compromised by increasing the efficiency and power production in a conventional thermal battery with use of a thinner electrolyte.

In accordance with the techniques discussed herein, the safety of a thermal battery is maximized by using a reinforced solid electrolyte to separate the fluid molten electrodes. The reinforced solid electrolyte may provide several other advantages in addition to safety. The use of a thinner solid electrolyte results in increased current flow and higher power with less heat generation since resistance to ion flow through the electrolyte is reduced. With the increased flow, the rate of charging and discharging is increased which results in a battery that requires less time to charge and that has a higher rate of energy production. Since less solid electrolyte material is required, the cost and weight of battery is also reduced. For example, a suitable solid electrolyte may comprise lithium iodide (LiI) where a reduction in the amount of the LiI salt results in lower cost and weight due to the relatively high cost and high density of LiI. Such advantages may be useful in numerous applications where some of the benefits may be more valuable in certain applications. For example, rapid charging capability, lower weight, and lower cost may be especially advantageous in electrical vehicles. Where the battery is used to power aerial vehicles, lower weight and higher power capability may be critical since takeoff and landing of such vehicles typically requires intense bursts of high energy from a lightweight power source where the weight of the battery directly and acutely impacts the payload capability and range of the vehicle.

For the examples herein, the reinforced solid electrolyte is formed with a reinforcing structure disposed adjacent to the solid electrolyte. In some situations, the reinforcing structure may be included only along a single side of the solid electrolyte. In other situations, the reinforcing structure includes two portions including a negative region component and a positive region component where the negative component is positioned between the solid electrolyte and the negative electrode and the positive component is positioned between the solid electrolyte and the positive electrode. In still other situations, a third component may be used along the edge of the solid electrolyte that is not facing either electrode. The third component may sometimes also function as a sealing component. As discussed below, for example, where a non-brittle electrolyte is formed with a material with a melting point higher, but relatively near, the operating temperature range of the battery, the third component of the reinforcing structure may provide support and seal the edge of the solid electrolyte. Since such a solid electrolyte maybe somewhat soft and yielding near its melting point, the solid electrolyte may be susceptible to movement, shifting, or other deformation when the apparatus is exposed to internal or external forces. In some situations, therefore, a third component of the reinforcing structure may provide additional structural support as well as provide a seal for the solid electrolyte.

At least the negative region component and the positive region component have an open geometry that allows electrode material to flow through the reinforcing structure. The negative region component and/or the positive region component may be electrically conductive in some circumstances. Although the third component may have an open structure in some situations, the third component does not typically have an open structure and has a geometry that prevents flow of materials through the third component in addition to having a structure that minimizes movement or deformation of the solid electrolyte. Additional components of the reinforcing structure may be used in still other situations which may depend on the geometry, shape, and size of the solid electrolyte as well as characteristics of other battery components.

The reinforcing structure may be used with different types of solid electrolytes including glass and ceramic electrolytes as well as solid electrolytes formed with materials having cations of the negative electrode material. Such solid electrolyte materials may include salts that are solid at the operating temperature of the apparatus. In some situations, the solid electrolyte may include defects caused by or maintained by the introduction of nanoparticles and/or other structures within the electrolyte materials.

In one example, the electrolyte is relatively non-brittle where the electrolyte material has a solid yet relatively soft, less brittle structure compared to ceramic and glass, within the operating temperature range of the battery. Such as an electrolyte is significantly less susceptible to cracking and fractures than conventional thermal batteries. The electrolyte comprises cations of the negative electrode material and anions. For the examples herein, the anion is selected to be relatively large and chemically stable with the materials within the reaction chamber. Therefore, in the examples, the anion is stable with the negative electrode material, the positive electrode material, and any resulting species of the materials. For a specific example discussed below, the negative electrode comprises lithium and the solid electrolyte is lithium iodide (LiI) which comprises lithium cations (Li⁺) and iodide anions (I⁻). The electrolyte may include other elements and additives in some circumstances. Even where the additives may have a brittle structure, the overall structure of the solid electrolyte in accordance with the techniques discussed herein is less brittle and less susceptible to cracking than ceramic electrolytes and glass electrolytes. By operating the battery at a temperature that is near but below the melting point of the LiI electrolyte, the electrolyte may become soft and may be less susceptible to cracking and fracture. For the examples herein, the solid electrolyte is reinforced by a reinforcing structure positioned between the solid electrolyte and each of the electrodes. Where the solid electrolyte is soft and relatively flexible, therefore, the reinforcing structure provides additional integrity and firmness. As a result, the thickness of the solid electrolyte may be reduced with minimal impact on safety. In other examples, a glass or ceramic solid electrolyte is supported by the reinforcing structure allowing a reduction in thickness of the electrolyte. The reinforcing structure lower costs and increases performance of a ceramic such as a beta-alumina solid electrolyte (BASE) ceramic. In another example, the solid electrolyte comprises lithium bromide (LiBr). A solid electrolyte comprising LiBr may be advantageous in high temperature implementations because of the relatively high melting point of LiBr. For space probes or other vehicles, for example, may benefit from a battery including a LiBr solid electrolyte. The LiBr may be part of salt mixture in some situations where the solid electrolyte is formed by a mixture of at least two salts. In other situations, the solid electrolyte may include only one salt, such as only LiI or LiBr.

For the examples discussed below, both the positive electrode and the negative electrode are in a fluid state when the battery is at a temperature within an operating temperature range of the battery. In some implementations, however, one of the electrodes may be in a solid state when the battery temperature is within the operating temperature range. In other words, only the positive electrode or the negative electrode is in a fluid state while the other is solid within the operating temperature range. In addition, in some circumstances, the operating temperature range may include temperatures where both electrodes are fluid and temperatures where only one electrode is fluid. When a material is in the fluid state, it is fluid, and when a material is in the non-fluid state, it is non-fluid. For the examples discussed herein, the electrode materials are transitioned from a non-fluid state to a fluid state by heating and can be referred to as molten electrode materials and molten fluid electrode materials. In situations where one of the electrodes is not fluid at the operating temperature, the reinforcing structure may only be disposed within the region of the fluid electrode.

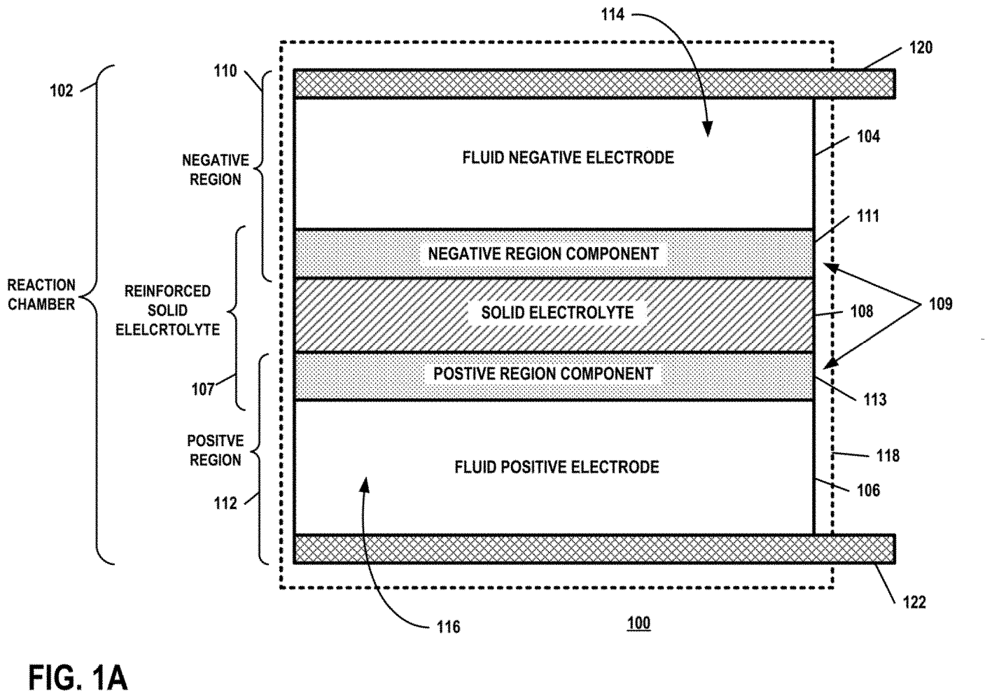

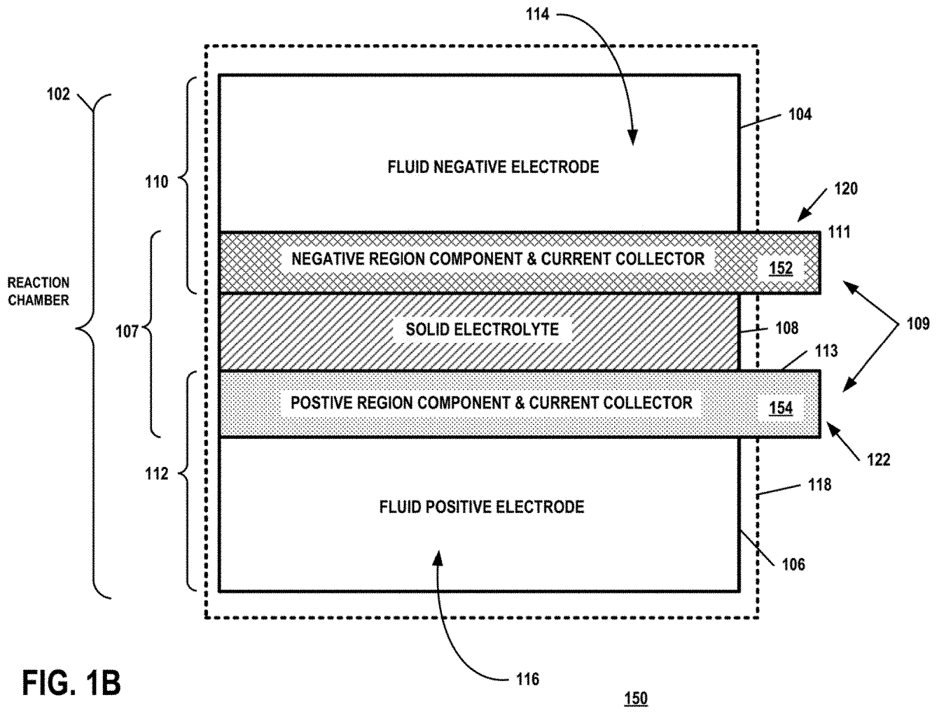

FIG. 1A is a block diagram of a cross-sectional view of an example of a battery apparatus 100 including a reaction chamber 102 having fluid electrodes 104, 106 separated by a reinforced solid electrolyte 107 including a solid electrolyte 108 with a reinforcing structure 109 positioned between the solid electrolyte 108 and each of the electrodes 104, 106. The illustration in FIG. 1A depicts some of the general principles of the example and does not necessarily represent specific shapes, relative sizes, distances, or other structural details of the represented components. In some circumstances, the structures of two or more blocks may be implemented in a single component or structure. In addition, functions described as performed in a single block of FIG. 1A may be implemented in separate structures. The orientation shown in the figures does not necessarily imply an orientation of the apparatus relative to the direction of gravity during operation. In some circumstances, for example, the fluid positive electrode may be positioned above the fluid negative electrode.

As discussed herein, a material is in a fluid state when the material has a consistency sufficiently liquefied to allow the material to flow from one area to another. In other words, the viscosity of a fluid material is such that the material can be directed, pumped, or can otherwise flow from one area to another. A fluid material may, however, have some components that are at least partially solid while others are in a liquid phase. As a result, a fluid material is not necessarily all in a liquid phase. As discussed herein, a material is in a non-fluid state where it is sufficiently solidified such that it cannot flow. In other words, the viscosity of the material in a non-fluid state is such that the material cannot be directed, pumped, or otherwise allowed to flow from one area to another. A non-fluid material, however, may have some components that are in a liquid phase as well as others that are in a solid phase. As referred to herein, a solid electrolyte is any material, mixture, compound, or other combination of materials that forms an electrolyte structure that is in a solid phase. Although the solid electrolyte is in the solid phase within the operating temperature range, some electrolyte materials may soften as the temperature approaches their respective melting points. Therefore, when the solid electrolyte 108 is operated near its melting point and subjected to stress, it can absorb at least some energy prior to fracture and exhibits more plastic deformation than glass and ceramics. In other words, some solid electrolytes are softer and exhibit a higher creep rate than glass and ceramics at the operating temperature of the battery.

The battery 100 includes at least a reaction chamber 102 having a negative electrode region 110 and a positive electrode region 112 separated from the negative electrode region 110 by the solid electrolyte 108. For the example of FIG. 1A, the reinforcing structure 109 includes a negative region component 111 in the negative electrode region 110 and a positive region component 113 in the positive electrode region 112. In some situations, one of the components 111, 113 can be omitted. The negative electrode region 110 contains a negative electrode material 114 and the positive electrode region 112 contains a positive electrode material 116. The negative region component 111 is positioned adjacent to, and in contact with, the solid electrolyte 108 to provide mechanical support to the solid electrolyte 108. The positive region component 113 is adjacent to, and in contact with, the solid electrolyte 108 to provide mechanical support to the solid electrolyte 108. Since the reinforcing structure components 111, 113 have an open geometry, each fluid electrode material 114, 116 permeates the respective reinforcing structure component 111, 113. As a result, the reinforced solid electrolyte 107 overlaps with each of the regions 110, 112. The negative fluid electrode 104 extends through the negative region component 111 such that the negative fluid electrode 104 contacts the solid electrolyte 108. The positive fluid electrode 106 extends through the positive region component 113 such that the positive fluid electrode 106 contacts the solid electrolyte 108. Where the solid electrolyte material has a melting point near the operating temperature of battery, the relatively soft solid electrolyte 108 may enter a small distance into the open geometry reinforcing structure at the interface between the solid electrolyte and the reinforcing structure.

In some situations, at least one of the reinforcing structure components extends more than a small distance into the solid electrolyte 108. During manufacturing, the solid electrolyte 108 may be heated to a sufficiently high temperature to allow the reinforcing structure to be partially implanted into the solid electrolyte 108. Such a technique may allow for the reinforcing structure to introduce defects within the lattice of the solid electrolyte structure and to strengthen the solid electrolyte material in addition to providing mechanical support. In one example, the reinforcing structure is a single unit that extends from negative electrode, through the solid electrolyte, into the positive electrode. In such configurations, however, the reinforcing structure is electrically nonconductive. As a result, the material of the reinforcing structure is nonconductive or a nonconductive coating is applied to the electrically conductive material of the reinforcing structure.

The battery apparatus 100 also includes a heating system 118 for sufficiently heating the positive and negative electrode materials in the reaction chamber 102 during operation. The electrode materials 114, 116 are maintained in a fluid state when the battery 100 is operating by heating the electrode materials 114, 116 while maintaining the solid electrolyte 108 in a solid state. Accordingly, the operating temperature of the reaction chamber is below the melting point of the solid electrolyte 108. For the example of FIG. 1A, the heating system 118 is an electrical heating system including one or more heating elements that facilitate the heating of the reaction chamber 102 to place and maintain the electrode materials 114, 116 in a fluid state. Other types of heating systems 118 can be used in some circumstances. The heating system heats the reaction chamber such that the negative electrode material 114 and the positive electrode material 116 are in a fluid state while the solid electrolyte 108 is maintained in a solid state.

In some examples, the solid electrolyte 108 includes at least cations of the negative electrode material 114 and anions where the anion is selected to be relatively large and chemically stable with the materials within the reaction chamber 102. Some examples of negative electrode materials 114 include lithium, sodium, potassium, rubidium, and cesium. Some examples of anions include anions of fluorine, chorine, bromine and iodine. Other materials can be used in some circumstances.

The fluid negative electrode material 114 in the negative electrode region 110 forms a fluid negative electrode 104 of the battery 100. The fluid positive electrode material 116 in the positive electrode region 112 forms a fluid positive electrode 106 of the battery 100. The fluid electrodes 104, 106 and the electrode materials may include more than a single element. For example, the positive electrode region 112 may also contain some reaction products resulting from the reaction within the battery 100. A first current collector 120 is positioned within the fluid negative electrode 104 and second current collector 122 is positioned within the positive fluid electrode 106. With the properly placed current collectors 120, 122 within each electrode 104, 106, electrical energy can be harnessed from the electrochemical reaction occurring within the battery between the fluid negative electrode 104 and the fluid positive electrode 106 through the solid electrolyte 108.

As discussed below with reference to FIG. 1B, the reinforcing structure components 111, 113 may be implemented to be current collectors in some situations. In situations where a reinforcing structure component functions as a current collector, the component is electrically conductive. At least one of the components 111, 113 of the reinforcing structure 109, therefore, may be electrically conductive.

As mentioned above, other materials may be present within the open structure in some circumstances. For example, in implementations where the negative electrode includes lithium and the positive electrode includes sulfur, lithium-sulfur reaction products may form in the positive electrode region 112. In at least some situations, these reaction products form in the region between the solid electrolyte 108 and the positive current collector and, therefore, may be within the positive region reinforcing structure component 113.

Although the materials of the negative region component 111 and the positive region component 113 may be the same in some circumstances, the material and structure of each component 111, 113 is selected based on particular environment where the component 111, 113 is positioned. The materials may be selected based on several factors including the electrode materials and at least some characteristics of the solid electrolyte 108. In many situations, the materials are selected based on cost, compatibility with other battery materials, and strength to weight ratio. The material of each of the negative region component 111 and the positive region component 113 are selected to be stable with the chemistry of the electrode material and any reaction products within the electrode region where the component is disposed. The reinforcing structure material is also selected to be chemically stable with the solid electrolyte material. Other factors that may be considered in selecting the material of the reinforcing structure 109 include the strength, softness, brittleness of the solid electrolyte 108 where the characteristics of the solid electrolyte 108 may be related to the thickness of the solid electrolyte 108 and the level of any defects in the lattice of the solid electrolyte material such as those introduced with nanoparticles and aliovalent substitution in the lattice.

Additional factors that may be considered when selecting the structure and material include the level of expected forces on the solid electrolyte 108 during operation of the battery including internal forces and as well as external forces exerted on the battery from the environment in which the battery is deployed. An example of an internal force on the reinforced solid electrolyte 107 includes forces due to vapor pressure of at least one of the fluid electrodes. Examples of external forces include forces due to acceleration and deceleration of the battery during operation. Where the battery is deployed in an aerial vehicle, such as a military fighter jet, electric aerial fighter, or unmanned aerial vehicle (UAV), forces on the battery experienced during takeoff, landing, and in-flight maneuvers may be considered. Where the battery is deployed in a terrestrial vehicle such as an electric car, forces due extreme deceleration during a crash may be considered in addition to the forces that may be present during normal operation of the vehicle.

In some situations, one or more reinforcing structure components with an open geometry may include a coating material disposed on the surfaces of the structure. Such a coating may be selected based on characteristics such as the chemical stability with the electrode material and electrical conductivity.

The selection of the reinforcing structure material is also dependent on the structure/geometry, shape and size of the reinforcing structure components in the overall design of reinforcing structure. Examples of the factors that may be considered in selecting the shape and geometry include at least the examples discussed above regarding material selection. In most situations, the design of the reinforcing structure 109 involves tradeoffs between the various factors, characteristics and objectives.

Generally, the material, size (including thickness), internal geometry (including the size of openings within the structure) of each component 111, 113 of the reinforcing structure 109 are selected to optimize performance while maintaining a desired strength of the structure. In some situations, computer modeling is used to optimize electrode material flow, strength and other structural and performance characteristics of each component 111, 113. For example, computational fluid dynamics (CFD) can be used to analyze fluid flows using numerical analysis and data structures in order to optimize performance. Finite element analysis, therefore, can be applied to design the reinforcing structure 109. Examples of suitable materials for the negative region component and the positive region component are discussed further detail below.

The operation of the reaction chamber 102 in the example of FIG. 1A is similar to the operation of conventional thermal batteries. The reinforced solid electrolyte, however, provides a significant advantage over conventional thermal batteries. Since the solid electrolyte is reinforced with a reinforcing structure, the electrolyte is much more resistant to cracking, breaking, deformation, and perforation, as compared to conventional solid electrolytes used in thermal batteries. Although solid electrolytes have been suggested, none of the conventional techniques contemplate using a solid electrolyte with reinforcing structure that at least provides structural support. The reinforcing structure may help to address the limitations of the solid electrolytes and thereby provide advantages to all types of solid electrolytes. As discussed above, for example, ceramic and glass electrolyte materials are brittle and are susceptible to cracking and failure with dangerous consequences without structural reinforcement. Other electrolyte materials with melting points near the operating temperature of the battery are susceptible to deformation and possible perforation when used in a relatively thin form factor without mechanical support provided by a reinforcing structure.

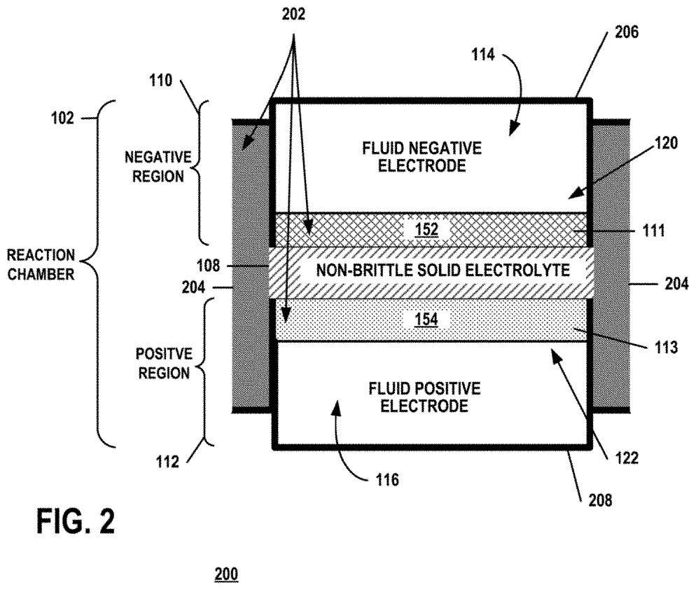

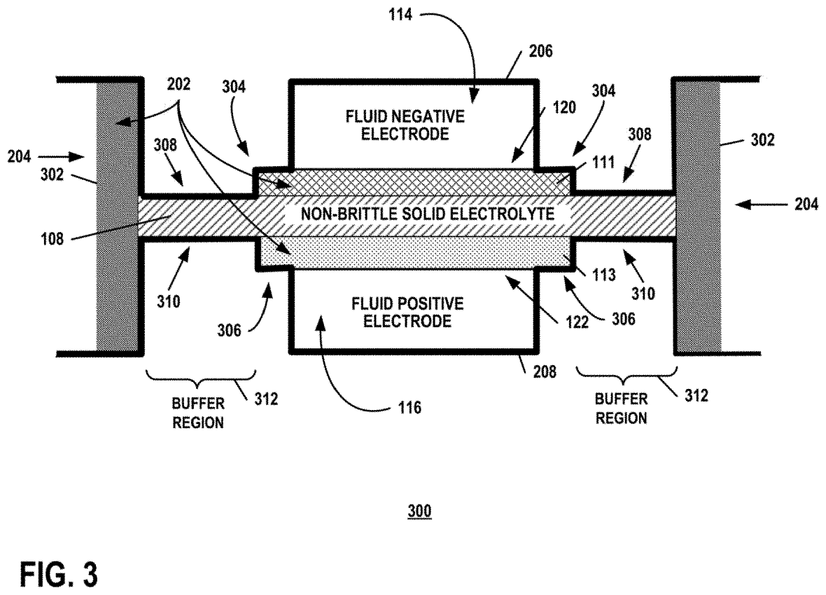

The battery apparatus 100 may be implemented with different materials and electrochemical couples. For the examples discussed below with reference to FIG. 2 and FIG. 3, the negative electrode comprises lithium (Li) and the positive electrode comprises sulfur (S). In another example, a sodium-sulfur (NaS) battery includes a fluid negative electrode comprising sodium (Na) and a fluid positive electrode comprising sulfur (S). In addition, other materials may also be used for the electrodes. Further, the electrode materials may contain mixtures or compounds that include multiple elements in some circumstances. For example, in some liquid metal batteries, a molten mixture of sulfur and phosphorus can be used for the fluid positive electrode.

The operating temperature, or temperature ranges, of the negative electrode region and positive electrode region may be selected based on several factors including, for example, the melting point of the negative electrode material, the melting point of the positive electrode material, the boiling point of the negative electrode material, the boiling point of the positive electrode material, the eutectic point of the positive electrode material and resulting chemical species, and the melting point of the solid electrolyte. For the examples discussed herein, the heating system 118 maintains the negative electrode region 110 and the positive electrode region 112 of the reaction chamber 102 at the same temperature in order to avoid a temperature gradient across the solid electrolyte 108. In some situations, the two regions of the reaction chamber may be maintained at different temperatures.

For the examples herein, a reinforced solid electrolyte allows for designs with thinner solid electrolytes while improving performance, reliability, and safety. The likelihood of cracking and breakage of ceramic and glass electrolytes is minimized with the reinforcing structure. Batteries with other types of solid electrolytes also benefit from that reinforcing structure at least in that the thickness of the solid electrolyte is minimized increasing the performance of the battery while maintaining reliability and safety of more pliable and softer electrolyte as compared to ceramic and glass. Although a softer solid electrolyte is less prone to cracking, such an electrolyte may experience increased deformation and the possibility of perforation or tearing as the thickness of the solid electrolyte material is reduced. The reinforcing structure minimized deformation, movement, and the chances of perforation of the solid electrolyte. In addition, a reinforcing structure component with sealing properties may be positioned adjacent to electrolyte surfaces not exposed to an electrode material to further reduce deformation and movement while providing a seal. The selection of a particular solid electrolyte material may require the thickness of the solid electrolyte to be minimized in order to facilitate the desired cation transport properties. The reinforcing structure provides a mechanism to minimize the solid electrolyte thickness. As mentioned above, for example, LiBr is suitable material for the solid electrolyte in some implementations although its ionic conductivity may be less than other material options. The reinforcing structure facilitates thinner LiBr electrolytes that facilitate an increased ion flow through the electrolyte.

In at least some examples, therefore, the apparatus includes a reaction chamber having negative region and a positive region where the negative region contains a negative molten fluid electrode comprising negative molten fluid electrode material being fluid at least within the operating temperature range of the apparatus and the positive region contains a positive molten fluid electrode comprising positive molten fluid electrode material being fluid at least within the operating temperature range of the apparatus. A reinforcing structure at least provides structural support to a solid electrolyte positioned between the negative molten fluid electrode and the positive molten fluid electrode such that the reinforcing structure forms a reinforced solid electrolyte with the solid electrolyte. The reinforced solid electrolyte has a reinforced solid electrolyte strength greater than a solid electrolyte strength of the solid electrolyte without the reinforcing structure. In at least some examples, the reinforcing structure includes a negative region reinforcing structure component and a positive region reinforcing structure. The negative region reinforcing structure component is positioned adjacent to the solid electrolyte in the negative region of the reaction chamber and has an open geometry configured to allow the negative electrode material to flow through the geometry during operation of the apparatus and to contact the solid electrolyte. The positive region reinforcing structure component is positioned adjacent to the solid electrolyte in the positive region of the reaction chamber and has an open geometry configured to allow the positive electrode material to flow through the geometry during operation of the apparatus.

FIG. 1B is a block diagram of a cross-sectional view of an example of a battery 150 with electrolyte reinforcing current collectors 152, 154 where components 111, 113 of the reinforcing structure form current collectors 120, 122. The battery 150, therefore, is an example of the apparatus 100 where the electrolyte reinforcing current collectors perform the functions of the reinforcing structure components 111, 113 and the current collectors 120, 122. A negative region electrolyte reinforcing current collector 152 performs the functions of a reinforcing structure negative region component 111 and a negative current collector 120. A positive region electrolyte reinforcing current collector 154 performs the functions of a reinforcing structure negative region component 113 and a negative current collector 122. The illustration in FIG. 1B depicts the general principles of the example and does not necessarily represent specific shapes, relative sizes, distances, or other structural details of the represented components.

FIG. 2 is a block diagram of a cross-sectional view of an example of a battery 200 with a reinforcing structure 202 including a negative region component 111, a positive region component 113, and a third component 204. For the example of FIG. 2, the solid electrolyte 108 is a non-brittle solid electrolyte that has a softness greater than ceramic and glass within the operating temperature range of the battery 200. Also in the example, the negative region component 111 forms a negative current collector 120 and the positive region component 113 forms a positive current collector 122. The example of FIG. 2, therefore, includes electrolyte reinforcing current collectors 152, 154. The negative electrode material 114 includes fluid lithium (Li) and the positive electrode material 116 includes fluid sulfur (S) during operation of the battery 200 in the example. The solid electrolyte 108 comprises solid lithium iodide (LiI). The battery 200, therefore, includes a fluid lithium (LiI) negative electrode and a fluid sulfur (S) positive electrode separated by a reinforced lithium iodide (LiI) solid electrolyte. Accordingly, the battery 200 can be referred to as a lithium-sulfur (US) battery and is an example of the battery 100, 150 where the fluid negative electrode comprises lithium, the fluid positive electrode comprises sulfur and the solid electrolyte comprises solid lithium iodide (LiI). The techniques discussed with reference to FIG. 2, however, may be used with different materials and configurations where the techniques may be more advantageous in situations where the solid electrolyte 108 is relatively soft and non-brittle. The illustration in FIG. 2 depicts the general principles of the example and does not necessarily represent specific shapes, relative sizes, distances, or other structural details of the represented components. In some circumstances, the structures of two or more blocks may be implemented in a single component or structure. In addition, functions described as performed in a single block of FIG. 2 may be implemented in separate structures.

The negative region reinforcing structure component 111 and the positive region reinforcing structure component 113 operate in accordance with the description with reference to FIG. 1A and FIG. 1B. The third component 204 provides additional structural support to the solid electrolyte 108. In some situations, the third component 204 may also seal at least one edge of the solid electrolyte 108 in addition to providing support. Since the solid electrolyte is operated near its melting point, the solid electrolyte 108 is relatively flexible and possibly susceptible to deformation due to forces experienced during operation of the battery 200. The third component 204, the negative region reinforcing structure component 111, and the positive region reinforcing structure component 113 collectively secure the solid electrolyte 108 to minimize movement, deformation, and damage to the solid electrolyte 108. For the example, the third component 204 is electrically nonconductive, sufficiently impermeable, chemically compatible with the solid electrolyte, and sufficiently strong to support the solid electrolyte. The composition of the third component may be further selected based upon its ability to form a seal and its compatibility with the molten electrode materials as well as cost. In situations where the third component does not provide a sealing function, additional battery components may be required to insulate the solid electrolyte from external elements. An additional hull, for example, may be needed to seal the solid electrolyte from the environment. An example of suitable material of the third component 204 of the reinforcing structure 202 that forms a seal comprises mica or boron nitride.

The third component 204 is positioned between a negative hull portion 206 and a positive hull portion 208. The hull portions 206, 208 are metal and are chemically stable with the materials of the electrodes 104, 106, solid electrolyte 108, and reinforcing structure components 111, 113, 204. In situations where the metal material of the hull portions 206, 208 is not chemically stable with the electrodes, a chemically stable coating can be applied to the hull portions 206, 208. Since the hull portions 206, 208 are electrically conductive, the portions 206, 208 are not in contact with each other.

In addition to considerations such as melting point, softness, and cost, selection of an electrolyte material for the LiS thermal battery includes evaluating ionic transfer properties and the chemical stability of the material with lithium, sulfur and the Li₂Sₘ species. Experiments performed by the inventor have revealed that lithium iodide is chemically stable with lithium, sulfur and the Li₂Sₘ species at elevated temperatures.

The operation of the LiS battery 200 is in accordance with the operation described with reference to the batteries 100, 150 of FIG. 1A and FIG. 1B. The heating system 118 (not shown in FIG. 2) maintains the reaction chamber 102 at the appropriate temperature to facilitate the desired reaction between the sulfur and lithium through the reinforced lithium iodide electrolyte 108. For the example of FIG. 2, the temperature of the negative electrode region 110 and the positive electrode region 112 is maintained at a temperature around 400 degrees Celsius (° C.). The operating temperature may be based on several factors including the characteristics of the materials of the electrodes and solid electrolyte. For the example of FIG. 2, some of the characteristics that can be considered include the melting point of lithium iodide, 469° C. the boiling point of sulfur, 444.6° C., and the eutectic melting point of lithium polysulfide products (LiₙSₘ), 365° C. A temperature range that is above the eutectic melting point of lithium polysulfide products but below the melting point of LiI provides the temperature range of 365° C. to 469° C. that can be used in some circumstances. Maintaining the temperature below the boiling point of sulfur may be useful and provide a range of 365° C. to 444° C. that can be used in other circumstances. A suitable temperature range, however, includes temperatures between 375° C. and 425° C. The wider temperature range of 115.21° C. to 469° C. can also be used in still other situations. For the examples herein, the temperatures of the negative electrode region 110 and the positive electrode region 112 are maintained at approximately the same temperature. Among other advantages, such a scheme avoids a temperature gradient across the reinforced solid LiI electrolyte. In some situations, however, the temperatures may be different between the electrode regions. Other temperature ranges and schemes can be used as long as the electrode materials are fluid and the electrolyte is solid. As a result, the temperature of the positive electrode region 112 should be above the melting point of sulfur, 115.21° C., and the negative electrode region 114 should be above the melting point of lithium, 180.5° C.

During operation of the battery 200, the reaction may result in other compounds or products being formed. For example, in addition to the positive electrode region containing sulfur, the region may also contain di-lithium polysulfide species (Li₂Sₙ where n is two or higher) and di-lithium sulfide (Li₂S). Typically, the reaction through the electrolyte will result is several different chemical species such as Li₂Sₘ where m is an integer equal to one or more. Any number of chemical species may result and may include, for example Li₂S, Li₂S₂, Li₂S₄, and Li₂S₆ products as well as others in some circumstances. The production of these products and their impact on electrode material flow through the reinforcing structure may be considered in selecting the materials and geometry of at least some of the reinforcing structure components. With some design techniques, computational fluid dynamics (CFD), finite element analysis and/or other modeling techniques that take into account the reactive products may be used to analyze fluid flows using numerical analysis and data structures.

In some situations, additional materials may be added to the positive electrode material and/or to the negative electrode material. For example, phosphorus can be included in the positive electrode material resulting in a fluid phosphorus-sulfur positive electrode. According, another example of the fluid electrode battery apparatus 200 is a lithium phosphorus-sulfur (LiPS) battery. In one example, therefore, the positive electrode material comprises sulfur and, in another example, the positive electrode material comprises sulfur and phosphorous. Examples of suitable temperature ranges for the reservoirs and reaction chamber for a LiPS battery include the ranges discussed above with reference to the LiS battery 200 of FIG. 2.

Therefore, for the example discussed with reference to FIG. 2, the fire danger of a lithium thermal battery is further minimized by using a solid lithium iodide (LiI) electrolyte for the reinforced solid electrolyte. LiI provides the appropriate electrochemical properties for use as an electrolyte in a thermal lithium battery such as LiS battery while having a melting point adequately above the melting point of lithium, the melting point of sulfur, and the eutectic melting point of lithium polysulfide products (LiₙSₘ). In addition, the LiI electrolyte is chemically stable with lithium and sulfur as well as with Li₂Sₘ species. Within the operating temperature range the LiI electrolyte remains solid but exhibits more plastic deformation than glass and more than a ceramic such as BASE because its operating temperature is much closer its melting point.

In some circumstances, therefore, the selection of materials and operational temperature ranges for use in the thermal battery are at least somewhat based on the melting point of the electrolyte material. A useful ratio of a material's temperature is the homologous temperature, T_{H}. The homologous temperature is the ratio of the material's absolute temperature to its absolute melting point temperature. The homologous temperature is very useful because materials behave in similar ways when heated. For instance, when a material's temperature is much lower than its melting point temperature, the material is typically hard and its creep rate under stress is negligible. However, when a material's temperature approaches its melting point, then the material softens and its creep rate under stress increases. As an example, the homologous temperatures for the BASE and sodium borate glass solid electrolyte in a sodium-sulfur battery operating at 350° C. are 0.27 T_{MP} and 0.32 T_{MP} respectively. At these homologous temperatures, the BASE and sodium borate glass are hard and exhibit a negligible creep rate under stress. By selecting a combination of materials that result in an operating temperature where at least one electrode is fluid and the electrolyte material is below, but relatively near, its melting point, the solid electrolyte is less brittle and more effectively separates and seals the electrode materials from each other. In most circumstances, the low end of the operating temperature range is at least above 35 percent of the absolute melting point of the solid electrolyte (i.e., T_{H} of the solid electrolyte is 0.35 T_{MP}). As the low end of the operating temperature range is increased, the electrolyte is likely to have an increased softness and be less brittle. Therefore, the low end may be above 50, 60, 70, or 80 percent of the absolute melting point of the electrolyte (i.e., T_{H}=0.5 T_{MP}, 0.6 T_{MP}, 0.7 T_{MP}, 0.8 T_{MP}). In many circumstances, the high end of the operating temperature range may be limited by the boiling point of one of the electrode materials. In order to avoid having the electrode entering the gas phase, the high end of the operating temperature range should at least be lower than the lower boiling points of the positive electrode material and the negative electrode material. In some circumstances, the high end can be less than 99.9 percent of the lowest electrode material's absolute boiling point. In still other situations, the high end can be less than 95 percent of the lowest electrode material's absolute boiling point.

Applying these relationships to a lithium sulfur battery, suitable operating temperature ranges are in accordance with those discussed above. For example, operating the LiS battery with a LiI solid electrolyte in a temperature range of 390° C. to 410° C. is a range that is contained within the range from 89 percent of the absolute melting point of lithium iodide (i.e., T_{H}=0.89 T_{MP}) to 95 percent of the absolute boiling point of sulfur. As discussed above, the solid electrolyte may be formed with other salts, such as LiBr, for example. The temperature ranges will vary depending on the particular salt or salt mixture.

FIG. 3 is a block diagram of a cross-sectional view of an example of a battery 300 where the third component 204 is a sealing component 302. The reinforcing structure 202 includes a negative region component 111, a positive region component 113, and a third component 204 that also provides sealing functionality as a sealing component 302. The battery 300 is an example of the battery 200 described above with reference to FIG. 2 and has an operation in accordance with the operation of the battery 200.

The negative hull portion 206 and the positive hull portion 208 include securing features 304, 306 that secure the negative region component 111 and the positive region component 113 within the structure of the battery 300. For the example, a negative region component securing feature 304 includes a lateral hull portion that is adjacent and parallel to the negative region component 111 such that the component 111 is securely positioned against the solid electrolyte 108. Similarly, a positive region component securing feature 306 includes a lateral hull portion that is adjacent and parallel to the positive region component 113 such that the component 113 is securely positioned against the solid electrolyte 108. The securing features 304, 306 may be implemented in other ways. For example, tabs extending from the hull wall may be used instead of a bended hull shape.

The negative hull portion 206 and the positive hull portion 208 also include extension sealing features 308, 310 that provide a buffer region 312 between the electrode materials 206, 208 and the sealing component 302. The solid electrolyte 108 extends beyond the edges of the negative region 110 and the positive region 112 between the negative region extension sealing feature and the positive region extension feature 310. The length of the formed buffer region 312 is such that the interface between the sealing component 302 and the solid electrolyte 108 is sufficiently distant from the edge of the electrodes 104, 106 to avoid leakage of the electrode materials around the solid electrolyte.

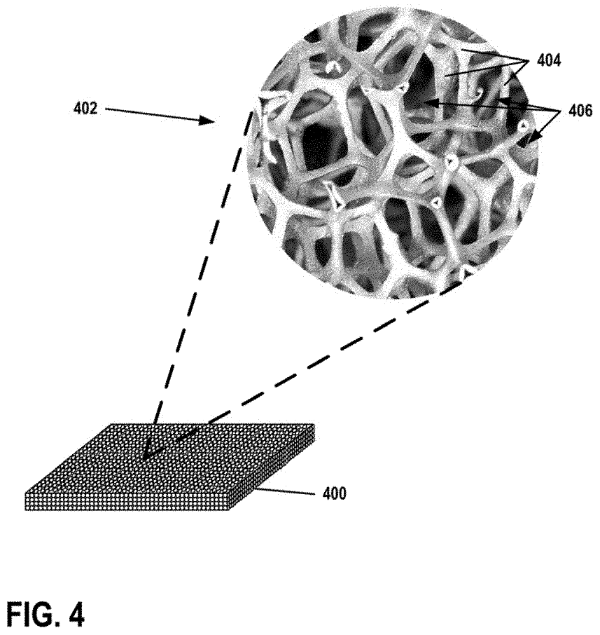

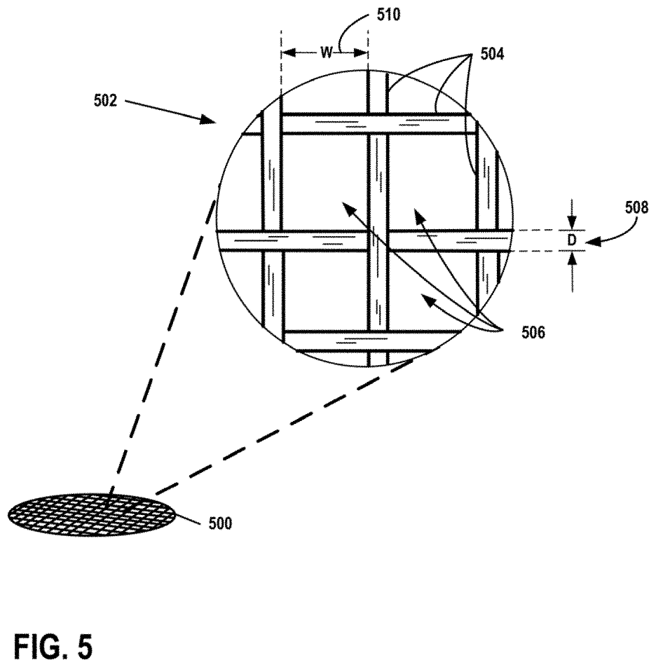

An example of suitable material of the sealing component 302 includes mica and boron nitride. Accordingly, the different components of the reinforcing structure 202 may be formed from a different material. Some examples of reinforcing structure materials for the negative region component 111 and the positive region component 113 include wire meshes and open cell foams. An example of an open cell foam material is discussed with reference to FIG. 4 and an example of a wire mesh is discussed with reference to FIG. 5. of different materials, such as metal foams, ceramic foams, glass foams, woven wire meshes, and fiberglass meshes. Other types of reinforcing structure materials can be used in some situations. Depending on the particular battery materials, a coating may be required to protect the reinforcement structure from chemical attack. Where the reinforcing structure material is electrically conductive, a dielectric material may be deposited onto the structure to transform the overall structure from electrically conductive to non-electrically conductive. Where the reinforcing structure component is used as a current collector, however, dielectric coatings are avoided where the reinforcing structure is metal although electrically conductive coatings may be used for protection against unwanted chemical interaction with the electrode materials. In some situations, an electrically conductive coating may be used on an electrically nonconductive reinforcing structure material.

Therefore, various materials, structures, and coatings may be used to form the reinforcing structure components. Some general characteristics of the negative region component 111 and positive region component 113 that may provide advantages include having an open cell structure, providing current collector functions, being electrically conductive, including iron for mechanical strength and have a coating. Examples of coatings that can be applied to the material including iron of a negative region component in a battery with molten fluid lithium include molybdenum, vanadium, niobium, tungsten and titanium. Examples of coatings that can be applied to the material including iron of a positive region component in a battery with molten fluid molten sulfur include molybdenum, W doped rutile titanium dioxide, and other doped rutile titanium dioxide materials.

FIG. 4 is an illustration of an example of a block of open cell foam 400 suitable for use as a reinforcing structure component 111, 113 to reinforce the solid electrolyte 108 within a thermal battery. The open cell foam structure may comprise a metal, a ceramic, carbon, a metal alloy, layer of a metal, multiple layers of differing metals or alloys, a layer of a ceramic, metal oxides that have been doped to make them electrically conductive. The reinforcing structure material is selected and processed to form a mechanically sound reinforcing structure that can withstand the operating temperatures of the battery and that is chemically stable and compatible with components of the battery that contact the reinforcing structure. Material is selected and processed to be electrically conductive or electrically non-conductive based on the requirements of battery design. A magnified view of the foam structure 402 in the example reveals a structure with structure components 404 separated by pores (open spaces) 406. The foam for the example has an open cell structure where the pores 406 between the components 404 of the foam 400 are interconnected. Examples of suitable open cell foam materials include carbon steel, cast iron, low alloy steels, stainless steels, such as SS316, SS304, and SS410, Titanium, Ti alloys, Ni alloys, Tungsten, W alloys, niobium, vanadium, ceramics (e.g. silicon carbide (SiC), B4C, magnesia (MgO), calcium oxide (CaO), boron nitride (BN), zirconia, cordierite, alumino-silicates, Macor®, Mullite, and aluminum nitride (AlN)), graphite, carbon, Steatite L-5, quartz, sapphire, silicon, silica glass, soda glass, borosilicate, brick, stone, and concrete.

FIG. 5 is an illustration of an example of a section of wire mesh 500 suitable for use as a reinforcing structure component 111, 113 to reinforce the solid electrolyte 108 within a thermal battery. The relative dimensions in FIG. 5 are not necessarily to scale. The wire mesh structure 500 may is formed with metal wires that may comprise a metals and metal alloys. The reinforcing structure wire mesh structure is selected and processed to form a mechanically sound reinforcing structure that can withstand the operating temperatures of the battery and that is chemically stable and compatible with components of the battery that contact the reinforcing structure. The material is selected and processed to be electrically conductive or electrically non-conductive based on the requirements of the battery design. A magnified view of the wire mesh structure 502 in the example reveals a structure with several weaved wires 504 that are separated sufficiently to provide openings 506. The wires have diameter, D 508 and the openings have width, W 510. The wire mesh 500 can also be characterized based on the number of wires per inch and the percentage of open area. Examples of suitable wire mesh materials include carbon steel, cast iron, low alloy steels, stainless steels, such as SS316, SS304, and SS410, Titanium, Ti alloys, Ni alloys, Tungsten, W alloys, niobium, vanadium, ceramics (e.g. silicon carbide (SiC), B4C, magnesia (MgO), calcium oxide (CaO), boron nitride (BN), zirconia, cordierite, alumino-silicates, Macor®, Mullite, and aluminum nitride (AlN)), graphite, carbon, Steatite L-5, quartz, sapphire, silicon, silica glass, soda glass, and borosilicate. The Examples of suitable Molybdenum wire mesh structures include Molybdenum wires meshes shown in Table 1 below.

TABLE 1

| | Wires/ | Wire Diameter | Width Opening | % Open |
|---|---|---|---|---|
| Example | Inch | (Inches) | (Inches) | Area |
| 1 | 100 × 100 | 0.0010 | 0.0090 | 81.0 |
| 2 | 50 × 50 | 0.0020 | 0.0180 | 81.0 |
| 3 | 35 × 35 | 0.0020 | 0.0266 | 86.5 |

It should be understood that, depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, rather than sequentially or even reversed. In addition, while certain aspects of this disclosure are described as being performed by a single module or component for purposes of clarity, it should be understood that the functions described in this disclosure may be performed by any suitable combination of components.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

What is claimed is:

1. An apparatus comprising:
a negative molten fluid electrode within a negative region of a reaction chamber, the negative molten fluid electrode comprising negative molten fluid electrode material being fluid at least within the operating temperature range of the apparatus;
a positive molten fluid electrode within a positive region of a reaction chamber, the positive molten fluid electrode comprising positive molten fluid electrode material being fluid at least within the operating temperature range of the apparatus;
a solid electrolyte positioned between the negative molten fluid electrode and the positive molten fluid electrode; and
a negative region reinforcing structure component positioned adjacent to the solid electrolyte in the negative region of the reaction chamber and having an open geometry configured to allow the negative electrode material to flow through the geometry during operation of the apparatus and to contact the solid electrolyte; and
a positive region reinforcing structure component positioned adjacent to the solid electrolyte in the positive region of the reaction chamber and having an open geometry configured to allow the positive electrode material to flow through the geometry during operation of the apparatus.

2. The apparatus of claim 1, wherein the solid electrolyte comprises a salt formed with a cation of the negative electrode material and wherein at least a portion of the solid electrolyte in a solid state at least within the operating temperature range of the apparatus.

3. The apparatus of claim 2, wherein the operating temperature range of the apparatus is contained within a range between 30 percent of an absolute melting point of the solid electrolyte and 99 percent of the absolute melting point.

4. The apparatus of claim 3, wherein the operating temperature range is contained within a range between 89 percent of the absolute melting point of the solid electrolyte and 95 percent of the absolute melting point.

5. The apparatus of claim 1, wherein the solid electrolyte comprises a beta-alumina solid electrolyte (BASE) ceramic.

6. The apparatus of claim 1, wherein the negative region reinforcing structure component and the positive region reinforcing structure component are electrically conductive.

7. The apparatus of claim 6, wherein the negative region reinforcing structure component forms a negative current collector and the positive region reinforcing structure component forms a positive current collector.

8. The apparatus of claim 7, wherein the negative region reinforcing structure and the positive region reinforcing structure comprise a metal.

9. The apparatus of claim 8, wherein the negative region reinforcing structure and the positive region reinforcing structure comprise iron coated with vanadium.

10. The apparatus of claim 1, wherein at least one of the negative region reinforcing structure and the positive region reinforcing structure is electrically nonconductive.

11. The apparatus of claim 10, wherein at least one of the negative region reinforcing structure and the positive region reinforcing structure comprises a metal coated with an electrically nonconductive coating.

12. The apparatus of claim 1, wherein:
the negative molten fluid electrode comprises lithium, the lithium being fluid at least within an operating temperature of the apparatus;
the positive molten fluid electrode comprises sulfur, the sulfur being fluid at least within the operating temperature of the apparatus; and
the solid electrolyte comprises a solid lithium salt.

13. The apparatus of claim 1, further comprising:
a third reinforcing structure component adjacent to at least one edge of the solid electrolyte not exposed to either the negative molten fluid electrode material or the positive molten fluid electrode material, the third reinforcing structure component restricting movement of the solid electrolyte.

14. The apparatus of claim 13, wherein the third reinforcing structure component forms a seal impermeable to the solid electrolyte, the negative molten fluid electrode material, and the positive molten fluid electrode material.

15. An apparatus comprising:
a reaction chamber comprising a negative electrode region separated from a positive electrode region by a solid electrolyte;
a negative molten fluid electrode comprising negative molten fluid electrode material within the negative electrode region and being fluid at least within the operating temperature range of the apparatus;
a positive molten fluid electrode comprising positive molten fluid electrode material with the positive electrode region being fluid at least within the operating temperature range of the apparatus;
a solid electrolyte comprising a salt formed with cations of the negative molten fluid electrode material, at least a portion of the solid electrolyte in a solid state at least within the operating temperature range of the apparatus;
a reinforcing structure forming a reinforced solid electrolyte having a reinforced solid electrolyte strength greater than a solid electrolyte strength of the solid electrolyte, the reinforcing structure comprising:
a negative region reinforcing structure component adjacent to the solid electrolyte and within the negative molten fluid electrode, the negative region reinforcing structure component having an open geometry configured to allow negative molten fluid electrode material to extend through the geometry to contact the solid electrolyte during operation of the apparatus; and
a positive region reinforcing structure component between the solid electrolyte and the molten fluid positive electrode, the positive region reinforcing structure component having an open geometry configured to allow positive molten fluid electrode material to extend through the geometry to contact the solid electrolyte during operation of the apparatus.

16. The apparatus of claim 15, wherein the reinforcing structure comprises a third reinforcing structure component adjacent to at least one edge of the solid electrolyte not exposed to either the negative molten fluid electrode material or the positive molten fluid electrode material, the third reinforcing structure component restricting movement of the solid electrolyte.

17. The apparatus of claim 16, wherein the third reinforcing structure component forms a seal impermeable to the solid electrolyte, the negative molten fluid electrode material, and the positive molten fluid electrode material.

18. The apparatus of claim 17, further comprising:
a negative region hull, the solid electrolyte with at least a portion of the negative region hull surrounding the negative molten fluid electrode material; and
a positive region hull, the solid electrolyte with at least a portion of the positive region hull surrounding the positive molten fluid electrode material,
the third reinforcing structure component positioned between the negative region hull and the positive region hull.

19. The apparatus of claim 15, wherein the negative molten fluid electrode material comprises lithium (Li), the positive molten fluid electrode material comprises sulfur (S), and the solid electrolyte comprises lithium (Li) cations.

20. The apparatus of claim 19, wherein the solid electrolyte comprises at least one of lithium iodide (LiI) and lithium bromide (LiBr).
